(19) United States
(12) Patent Application Publication
(10) Pub. No.: US 2002/0105498 A1
(43) Pub. Date: Aug. 8, 2002

(54) MULTI-WAY INPUT DEVICE

(76) Inventor: HISATO SHIMOMURA, MIYAGI-KEN (JP)

Correspondence Address: BRINKS HOFER GILSON & LIONE, P O BOX 10395, CHICAGO, IL, 60610

(21) Appl. No.: 09/333,276

(22) Filed: Jun. 14, 1999

(30) Foreign Application Priority Data
Oct. 5, 1998 (JP) 10-282393

(51) Int. Cl. G09G 5/08

(52) U.S. Cl. 345/161

(57) ABSTRACT

In the multi-way input device, an operating shaft is formed with a cylindrical potion which receives a return spring therein, and pivot shaft portions of a convex shape are formed on part of an outer wall of the cylindrical portion, the pivot shaft portions being engaged by snap-fitting with engaging portions of a concave shape formed in side walls of a second interlocking member which define a slot. This construction affords a high assembling work efficiency and dispenses with a round pin or the like so far used as pivot shaft portions. Besides, since the return spring is received in a receptacle space formed within the cylindrical portion, it becomes possible to reduce the thickness of the multi-way input device.

### BACKGROUND OF THE INVENTION

1. Field of the Invention

The present invention relates to a multi-way input device capable of operating a plurality of electric components at a time by operation of an operating shaft.

2. Description of the Related Art

A conventional multi-way input device is constructed as in FIGS. 11 to 13, in which a first interlocking member 31 curved in an arch shape is disposed in the interior of a frame 30, the frame 30 being formed in the shape of a box having side plates and which is open on its lower side. The first interlocking member 31 has mounting portions 31a formed respectively at both ends thereof. The mounting portions 31a are fitted respectively into holes 30c and 30a formed in side plates of the frame 30, whereby the first interlocking member 31 is mounted rotatably in the interior of the frame 30.

A hole 34 is formed in an end face of each mounting portion 31a and a rotary shaft 33 of a variable resistor 32 is press-fitted into the hole 34. Further, a slit 35 is formed longitudinally in the arched portion of the first interlocking member 31.

Below the first interlocking member 31 is disposed a second interlocking member 40 in a direction perpendicular to the first interlocking member. The second interlocking member 40 is centrally provided with a spherical body 41 and is also provided with right and left arm portions 42 extending horizontally from the spherical body 41, with circular mounting portions 42a being projectingly formed respectively at the tips of the arm portions 42. The mounting portions 42a are inserted respectively into holes 30b and 30d formed in the frame 30, whereby the second interlocking member 40 is mounted rotatably in the interior of the frame 30.

A hole 43 is formed in an end face of each mounting portion 42a and the rotary shaft 33 of another variable resistor 32 is press-fitted into the hole 43.

A slot 45 is vertically formed centrally through the spherical body 41. The first and second interlocking members 31, 40 are disposed in such a manner that the respective slit 35 and slot 45 intersect each other perpendicularly.

An operating shaft 36 is inserted through the slot 45 of the second interlocking member 40. The operating shaft 36 takes a shape such that an oval-shaped support portion 38 is formed at a center and upper and lower support rods are projected and integral with the support portion 38. A disc-like spring shoe 47 integral with the operating shaft 36 is formed at a position close to a lower end portion 36a of the operating shaft 36 projecting downward.

A small hole 39 is formed in the support portion 38 of the operating shaft 36. The hole 39 is aligned with a hole 44 formed sideways of the second interlocking member 40 and a round pin 46 is inserted or press-fitted into the thus-aligned holes 39 and 44, whereby the operating shaft 36 is mounted tiltably to the second interlocking member 40.

The operating shaft 36 extending upward from the support portion 38 is inserted through the slit 35 of the first interlocking member 36. By tilting the operating shaft 36 along the slit 35 of the first interlocking member 31, the second interlocking member 40 can be rotated with its mounting portions 42a as fulcrums. A knob 55 is fixed to the upper end of the operating shaft 36 which extends upward from the slit 35.

An operating member 37, which is formed dish-like in external form using a resin material for example, is secured to the lower end portion 36a of the operating shaft 36. A boss portion 37a is centrally projected on the operating member 37 and the end portion 36a of the operating shaft 36 is inserted into a bore 50 formed in the boss portion 37a so that the operating member 37 can move vertically.

A bottom plate 49 is mounted so as to cover the lower opening of the frame 30. In this state, the operating member 37 is in elastic contact with the bottom plate 49.

By tilting the operating shaft 36 along the slot 45 of the second interlocking member 40 with the round pin 46 as a fulcrum, the first interlocking member 31 can rotate with its mounting portions 31a as support shafts. Likewise, by tilting the operating shaft 36 along the slit 35 of the first interlocking member 31, the second interlocking member can rotate with its mounting portions 42a as support shafts.

The rotary shafts 33 of the variable resistors 32 locked to side plates of the frame 30 are press-fitted in the holes 34 and 43 of the first and second interlocking members so that both interlocking members and the variable resistors operate integrally with each other.

A generally conical return spring 48 is stretched between the spring shoe 47 of the operating shaft 36 and an inside bottom of the operating member 37. With the biasing force of the return spring 48 the operating member 37 is brought into elastic contact with the bottom plate 49, whereby the operating shaft 36 can be held in an upright neutral state.

The operation of the conventional multi-way inpout device will now be described. First, as shown in FIG. 12, the upper end of the operating shaft 36, when not in operation, projects upright from a hole 56 formed in a top plate of the frame 30 and the operating member 37 is kept in elastic contact with the bottom plate 49 in a horizontal state by means of the return spring 48, so that the operating shaft 36 is in an upright neutral state.

In this state, as shown in FIG. 13, by tilting the operating shaft 36, for example, clockwise along the slot 45 of the second interlocking member 40, the first interlocking member 31 is rotated, whereby the variable resistor 32 is operated and hence the resistance value thereof can be changed.

As a result of the tilting motion of the operating shaft 36, the operating member 37 tilts as in FIG. 13 and part of the peripheral edge of the thus-tilted operating member 37 moves in sliding contact with the surface of the bottom plate 49. Consequently, the operating member 37 moves toward the circular spring shoe 47, thereby causing the return spring 48 to be compressed and deflected.

Upon release of the operating force applied to the operating shaft 36, the operating member 37 which has been tilted comes to move in sliding contact with the surface of the bottom plate 49 with the biasing force of the return spring 48. The operating member 37 gradually comes to moves horizontally with respect to the bottom plate 49 and in this way the operating shaft 36 reverts automatically to its upright neutral state shown in FIG. 12.

For operating the variable resistor 32 engaged with an arm portion 42 of the second interlocking member 40, the operating shaft 36 is tilted along the slit 35 of the first interlocking member 31, whereby the second interlocking member 40 is rotated and this rotation permits operation of the variable resistor 32.

In the above conventional multi-way input device, however, since the return spring 48 is stretched between the spring shoe 47 and the inside bottom of the operating member 37 at a position below the round pin 46 which is a tilting fulcrum of the operating shaft 36, the distance from the round pin 46 to the operating member 37 is long, that is, the vertical size of the input device becomes large, thus making it difficult to reduce the thickness of the device.

Besides, since the round pin 46 is used for supporting the operating shaft 36 in the second interlocking member 40, not only the number of components used increases but also the operation for press-fitting the round pin 46 into the second interlocking member 40 is needed, thus making the assembling process so much complicated.

### SUMMARY OF THE INVENTION

It is an object of the present invention to solve the above-mentioned problems and provide a multi-way input device using a reduced number of parts, superior in assembling efficiency and low in cost.

According to the first means adopted by the present invention for solving the foregoing problems there is provided a multi-way input device comprising a first interlocking member which has a longitudinal slit and which is rotatable; a second interlocking member disposed in a direction orthogonal to the longitudinal direction of the first interlocking member, the second interlocking member having a slot and being rotatable; a frame within which the first and second interlocking members are mounted; an operating shaft inserted through both the slit of the first interlocking member and the slot of the second interlocking member and supported tiltably by the second interlocking member; a plurality of electric components attached to the frame and capable of being operated through the first and second interlocking members by operation of the operating shaft; a return spring which restores the operating shaft to an upright neutral state automatically when the operating shaft is not in operation; an operating member supported movably on a lower end portion of the operating shaft which is positioned in the interior of the frame; and a bottom plate with which the operating member comes into elastic contact under the biasing force of the return spring and which closes the bottom side of the frame, the operating shaft being provided with a cylindrical portion having a receptacle space for receiving the return spring therein, the cylindrical portion being pivotally supported within the slot of the second interlocking member.

According to the second means adopted by the invention for solving the foregoing problems there is provided, in combination with the above first means, a multi-way input device wherein the operating shaft has pivot shaft portions formed on part of an outer wall of its cylindrical portion, and the second interlocking member has engaging portions for engagement with the pivot shaft portions, the engaging portions being formed inside the slot of the second interlocking member, the pivot shaft portions of the operating shaft being brought into engagement with the engaging portions of the second interlocking member to pivotally support the operating shaft in the second interlocking member.

According to the third means adopted by the invention for solving the foregoing problems there is provided, in combination with the above second means, a multi-way input device wherein the pivot shaft portions of the operating shaft are formed in a convex or concave shape and the engaging portions of the second interlocking member are formed in a concave or convex shape engageable with the pivot shaft portions.

According to the fourth means adopted by the invention for solving the foregoing problems there is provided, in combination with the above first means, a multi-way input device wherein the operating member has a base portion whose bottom is dish-like and a boss portion formed at the center of the base portion and projecting toward the interior of the frame, a lower end portion of the operating shaft is inserted into an axial bore formed in the boss portion of the operating member, and the boss portion being fitted movably in the receptacle space of the operating shaft.

According to the fifth means adopted by the invention for solving the foregoing problems there is provided, in combination with the above fourth means, a multi-way input device wherein the return spring received in the receptacle space of the operating shaft is in elastic contact with the boss portion of the operating member.

According to the sixth means adopted by the invention for solving the foregoing problems there is provided, in combination with the above fourth means, a multi-way input device wherein the bottom of the operating member has an external shape larger than the receptacle space of the operating shaft.

### BRIEF DESCRIPTION OF THE DRAWINGS

FIG. 1 is an exploded perspective view of a multi-way input device embodying the present invention;

FIG. 2 is a top view of a second interlocking member used in the multi-way input device;

FIG. 3 is a front view thereof;

FIG. 4 is a side view thereof;

FIG. 5 is a top view of an operating shaft used in the multi-way input device;

FIG. 6 is a front view thereof;

FIG. 7 is a sectional view taken on line 7-7 in FIG. 5;

FIG. 8 is a sectional view of a principal portion of the multi-way input device;

FIG. 9 is a sectional view of the principal portion of the multi-way input device, explaining the operation of the device;

FIG. 10 is a sectional view of a principal portion of the multi-way input device;

FIG. 11 is a perspective view of a conventional multi-way input device;

FIG. 12 is a sectional view of a principal portion thereof; and

FIG. 13 is a sectional view of the principal portion, explaining the operation of the conventional multi-way input device.

### DETAILED DESCRIPTION OF A PREFERRED EMBODIMENT

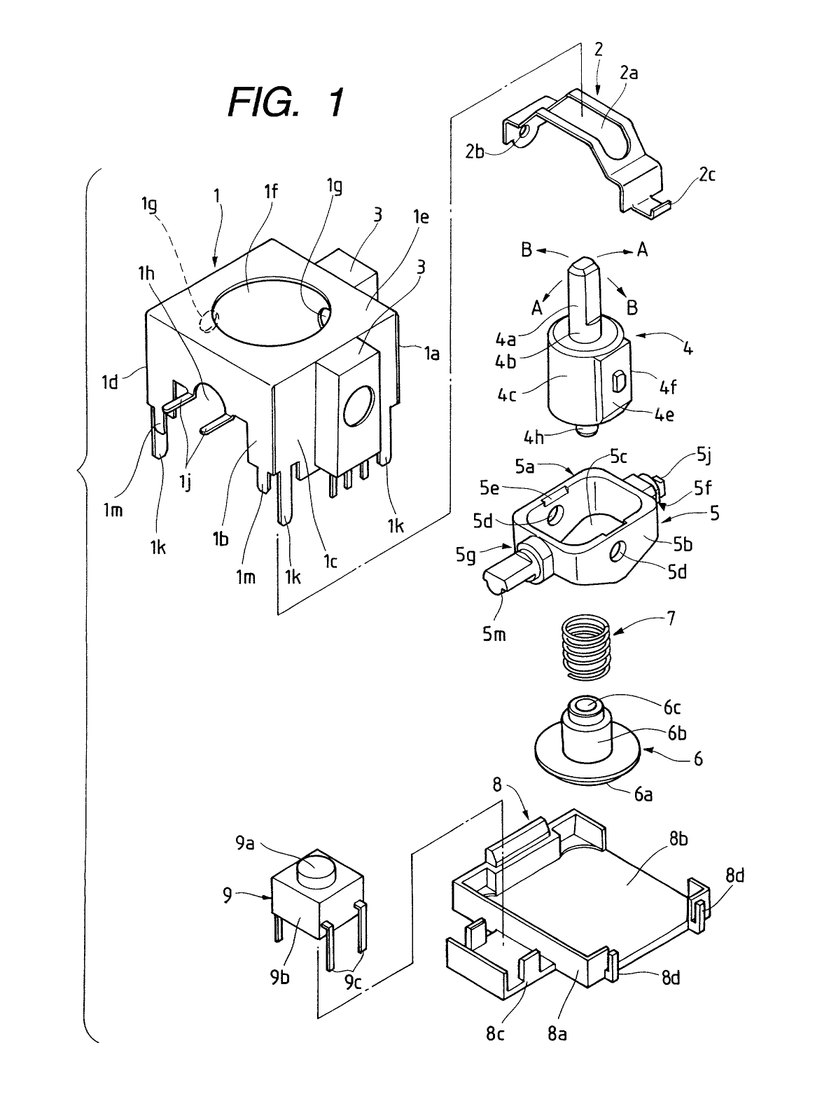

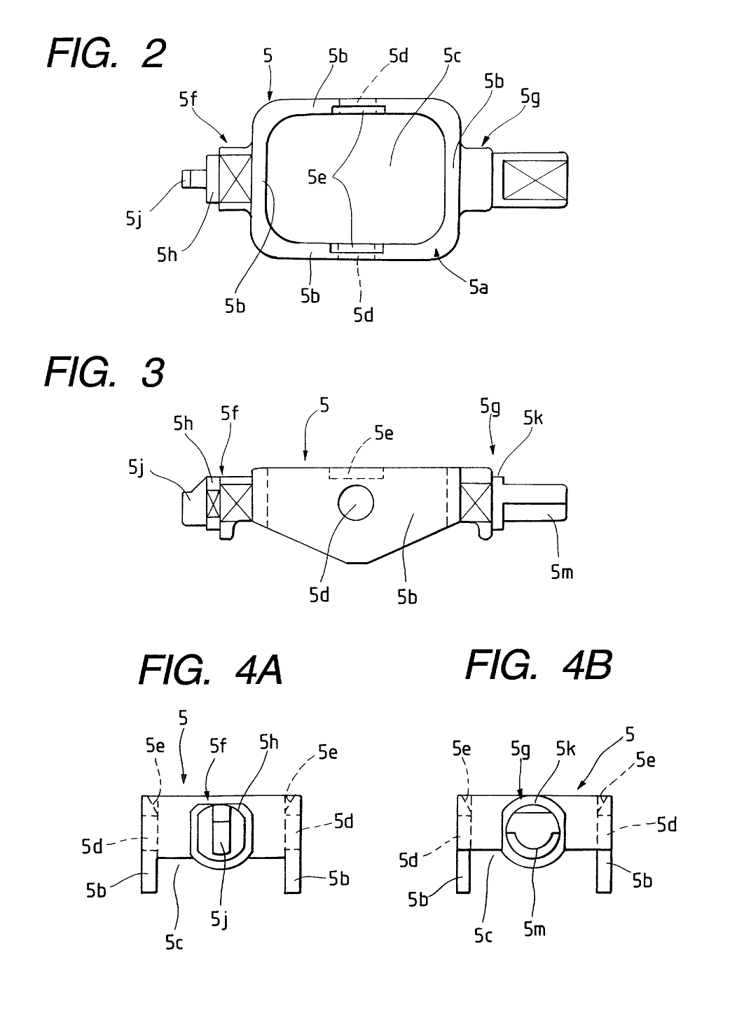

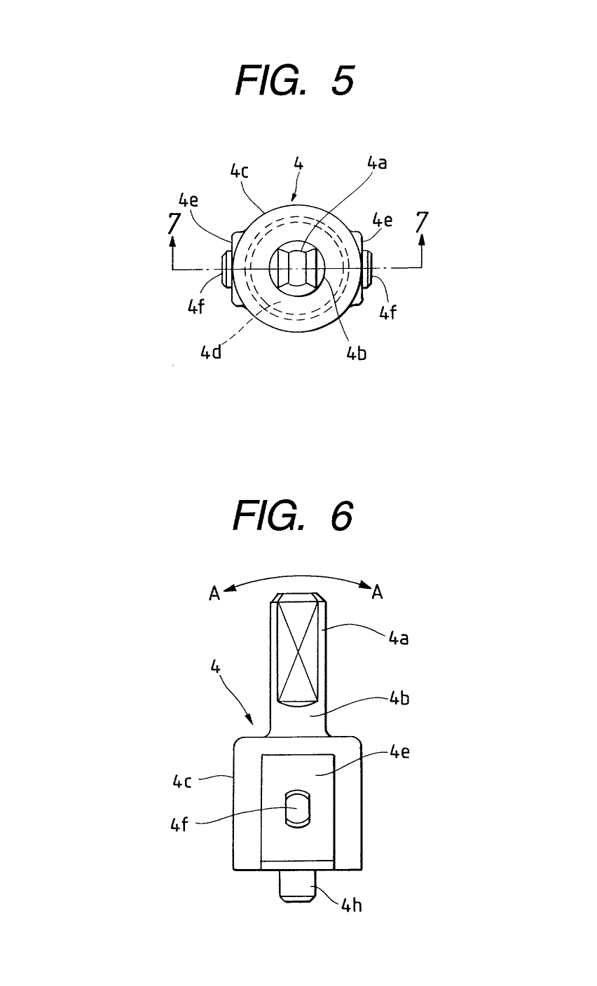

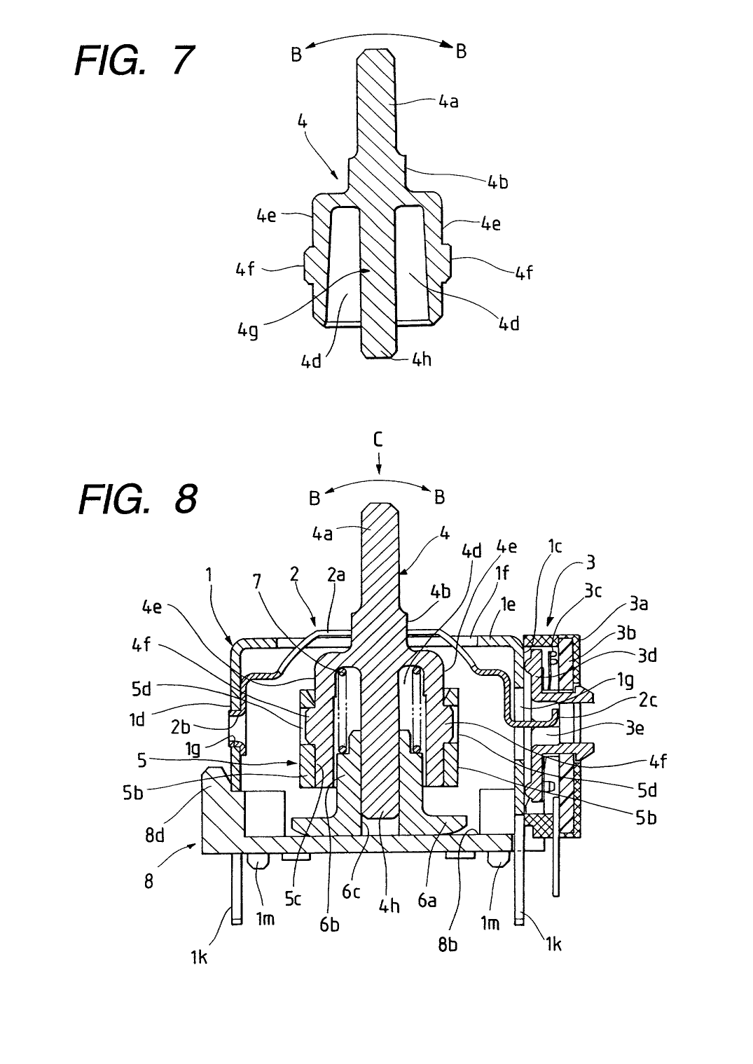

A multi-way input device according to an embodiment of the present invention will be described hereinunder with reference to FIGS. 1 to 10, of which FIG. 1 is an exploded perspective view of the multi-way input device, FIGS. 2 to 4 are diagrams illustrating a second interlocking member used in the multi-way input device, FIGS. 5 to 7 are diagrams illustrating an operating shaft used in the multi-way input device, and FIGS. 8 to 10 are diagrams illustrating the operation of the multi-way input device.

In the multi-way input device, as shown in FIG. 1, a frame 1 is disposed which is formed by an iron plate or the like. The frame 1 has side plates 1a, 1b, 1c and 1d formed by bending such as an iron plate downward in the figure by means of a press or the like. The frame 1 has a hollow interior and its bottom is open. Its external form is generally in the shape of a rectangular parallelepiped. The top of the frame 1 is covered with a top plate 1e, with an operating hole 1f being formed centrally in the top plate 1e.

Circular holes 1g are formed respectively in the three side plates 1a, 1c and 1d other than the side plate 1b. A plurality of rectangular apertures (not shown) for mounting variable resistors 3 as electric components, which will be described later, are formed in the side plates 1a and 1c. In the side plate 1b opposed to the side plate 1a is formed a support portion 1h of a generally semicircular shape at a position opposed to the circular hole 1g formed in the side plate 1a. On both right and left sides of the support portion 1h are formed component holding legs 1j which are bent outwards approximately at right angles from the side plate 1b.

A plurality of mounting terminals 1k for mounting the multi-way input device to a printed circuit board (not shown) are extended downward from the lower ends of the opposed side plates 1c and 1d.

Two tongue pieces 1m for mounting a bottom plate 8 which will be described later are formed at lower positions of each of the side plates 1a and 1b.

A first interlocking member 2 formed by such as a phosphor bronze plate is disposed within the hollow portion of the frame 1. The first interlocking member 2 is curved upward in an arch shape by means of a press or the like, and a slit 2a is formed longitudinally in the arcuate portion by punching.

Both end portions of the first interlocking member 2 are bent downward, and at the thus-bent left-hand end portion in the figure there is formed a pipe-like support portion 2b projectingly by drawing for example. The support portion 2b is inserted into the circular hole 1g of the side plate 1d, whereby the first interlocking member 2 is supported rotatably.

The opposite right-hand end portion in the figure of the first interlocking member 2 is bent in a general U shape to form a component operating portion 2c. The component operating portion 2c is inserted into a circular hole (not shown) formed in the side plate 1c of the frame 1 and projects outwards into engagement with a lateral groove formed in the slider receptacle portion 3d of a variable resistor 3 to be described later.

The first interlocking member 2 is connected bridgewise to the circular holes formed respectively in the side plates 1c and 1d of the frame 1, whereby its arcuate portion is mounted rotatably within the frame 1.

For example, two variable resistors 3 as electric components are attached by snap-fitting or any other suitable means to a plurality of rectangular holes (not shown) formed in the side plate 1a and the side plate 1c adjacent thereto of the frame 1.

Each variable resistor 3 has such a structure as shown in FIG. 8, in which a board 3b formed integrally by insert molding for example is disposed in the interior of a case 3a, the slider receptacle portion 3d with a slider piece 3c attached thereto is attached to the board 3b rotatably by snap-fitting for example, and an operating portion 3e having engaging grooves comprising vertical and lateral grooves is formed at a rotational center of the slider receptacle portion 3d.

The component operating portion 2c of the first interlocking member 2 projecting outwards from the circular hole (not shown) formed in the side plate 1c of the frame 1 engages the operating portion 3e of the variable resistor 3 attached to the side plate 1c so that the slider receptacle portion 3d of the variable resistor 3 rotates upon rotation of the first interlocking member 2 to change the resistance value of the variable resistor 3.

A knob portion 4a of the operating shaft 4 is inserted into the slit 2a of the first interlocking member 2. The knob portion 4a and a base end portion 4b of the operating shaft 4 are movable along the slit 2a. The operating shaft 4 is formed of a synthetic resin material. As shown in FIGS. 5 to 7, the knob portion 4a is formed in an oval shape and the base end portion 4b is formed in a circular shape. A cylindrical portion 4c having a hollow interior is integral with the circular base end portion 4b.

The cylindrical portion 4c is constituted by a peripheral wall and its lower side is open. In the interior of the cylindrical portion 4c is formed a hollow receptacle space 4d for receiving therein a generally coil-shaped return spring 7 which will be described later. As shown in FIG. 5, on the outer wall of the cylindrical portion 4c are formed two flat portions 4e in an opposed relation to each other, and on part of the flat portions 4e are respectively formed oval-shaped pivot shaft portions 4f convexly at predetermined diameter and height.

In the interior of the spring receptacle space 4d is integrally formed a shaft portion 4g coaxially with the knob portion 4a. The shaft portion 4g extends downward in the figure so that a lower end 4h thereof projects downward to a greater extent by a predetermined length than the spring receptacle space 4d.

The operating shaft 4 allows its pivot shaft portions 4f to be supported by a second interlocking member 5 and can thereby tilt in both arrow A-A and B-B directions.

The second interlocking member 5, which is formed of a synthetic resin material, is disposed below the first interlocking member 2 in a direction perpendicular to the first interlocking member 2.

As shown in FIG. 2, a support portion 5a of a generally rectangular shape is formed nearly centrally of the second interlocking member 5. The support portion 5a comprises long and short side walls 5b defining an inside space through which is formed a slot 5c of a generally rectangular shape.

A pair of engaging portions 5d for engagement with the pivot shaft portions 4f of the operating shaft 4 are formed respectively in predetermined positions of the long side walls 5b of the support portion 5a. The engaging portions 5d are formed through the side walls or in a concave shape having a predetermined depth. Further, chamfered guide portions 5e each of a predetermined size are formed respectively at inner edges of the long side walls 5b above the engaging portions 5d as in FIG. 3. When the operating shaft 4 is brought into engagement with the second interlocking member 5 by snap-fitting, the chamfered guide portions 5e permit the pivot shaft portions 4f to be guided smoothly into the engaging portions 5d.

As shown in FIG. 3, first and second arm portions 5f, 5g extend horizontally right and left from the support portion 5a. The first arm portion 5f extending on one side is formed with a support portion 5h of a predetermined diameter, and a plate-like component operating portion 5j of a predetermined width projects from the support portion 5h.

The second arm portion 5g extending on the other side is formed with a support portion 5k of a predetermined diameter, and a component operating portion 5m having a flat upper surface and a semicircular lower surface extends from the support portion 5k.

The support portion 5h of the first arm portion 5f in the second interlocking member 5 is inserted into the circular hole 1g formed in the side plate 1a of the frame 1 and is thereby supported rotatably, while the support portion 5k of the second arm portion 5g is positioned and supported in the semicircular support portion 1h of the side plate 1b. Thus, the second interlocking member 5 is supported rotatably and its component operating portion 5m as one end portion is mounted vertically movably in the interior of the frame 1.

The component operating portion 5j of the first arm portion 5f is engaged with the vertical groove formed in the operating portion 3e of the variable resistor 3 attached to the side plate 1a, while the component operating portion 5m of the second arm portion 5g is positioned on a stem portion 9a of an electric component such as a push-button switch 9 attached to a bottom plate 8 which will be described later.

An operating member 6, which is movable in the axial direction of the operating shaft 4, is disposed at the lower end 4h of the operating shaft 4, the operating shaft 4 being pivotally supported by the second interlocking member 5 and positioned in the interior of the frame 1.

The operating member 6 is formed of a resin material and has a base portion 6a on its lower side, the base portion 6a having a circular external form and having a dish-like curved bottom. Centrally on the base portion 6a is formed a cylindrical boss portion 6b projecting toward the interior of the frame 1, with an axial bore 6c being formed centrally in the boss portion 6b.

The lower end 4h of the operating shaft 4 is inserted into the axial bore 6c of the operating member 6 and the boss portion 6b is fitted in the receptacle space 4d of the cylindrical portion 4c movably.

A return spring 7 constituted by a coiled spring of a predetermined biasing force is disposed between the boss portion 6b of the operating member 6 and the cylindrical portion 4c of the operating shaft 4. The return spring 7 is disposed in such a manner that its upper and lower ends are in elastic contact respectively with the ceiling surface of the receptacle space 4d in the cylindrical portion 4c and with the upper surface of the boss portion 6c of the operating member 6. The return spring 7 is fitted on the shaft portion 4g and one end portion thereof located on the knob portion 4a side is guided by the inner wall of the cylindrical portion 4c, while the opposite end portion thereof is guided by the outer wall of the boss portion 6b, to restrict front, rear and right, left motions of the return spring.

Below the operating member 6 is disposed a bottom plate 8 with which the operating member 6 is brought into elastic contact by virtue of the return spring 7 and which closes the lower portion of the frame 1. The bottom plate 8 is formed in a generally rectangular external shape using a resin material and it comprises side walls 8a formed partially and a flat inner bottom 8b formed inside the side walls 8a.

A component mounting portion 8c for mounting an electric component such as a push-button switch 9 projects from one side wall 8a of the bottom plate 8. On the side walls 8a adjacent to the side wall 8a with the component mounting portion 8c formed thereon there are formed projectingly a plurality of guide portions 8d for positioning the lower ends of the side plates 1c and 1d of the frame 1.

The push-button switch 9 attached to the component mounting portion 8c comprises a stem portion 9a which can turn an internal circuit (not shown) ON and OFF, a case 9b which encloses the internal switch circuit therein in a hermetically sealed state, and a plurality of mounting terminals 9c extending downward from side faces of the case 9b. The mounting terminals 9c of the push-button switch 9 can be temporarily fixed to the component mounting portion 8c of the bottom plate 8 by snap-fitting for example.

In assembling the multi-way input device constructed as above, the first interlocking member 2 of an arcuate shape is inserted into the frame 1 from the lower open side of the frame and its component operating portion 2c is inserted into a circular hole (not shown) formed in the side wall 1c, while its support portion 2b is inserted into the circular hole 1g formed in the side plate 1d. In this way the first interlocking member 2 is mounted in the interior of the frame 1.

Next, the cylindrical portion 4c of the operating shaft 4 is inserted into the slot 5c of the second interlocking member 5 until the convex pivot shaft portions 4f are positioned on the chamfered guide portions 5e of side walls 5b. In this state, the operating shaft 4 is pushed down in the slot 5c with use of a jig (not shown) or the like, whereby the side walls 5b are deformed elastically and expanded outwards and hence the convex pivot shaft portions 4f are brought into engagement by snap-fitting with the concave engaging portions 5d of the side walls 5b. In this way the cylindrical portion 4c of the operating shaft 4 is pivotally supported within the slot 5c of the second interlocking member 5.

Thus, the flat portions 4e as outer walls of the cylindrical portion 4c of the operating shaft 4 are held within the slot 5c of the second interlocking member 5, allowing the operating shaft 4 to be supported by the second interlocking member 5.

Next, grease is applied into spaces formed by both-side linear portions in the oval shape of each pivot shaft portion 4f and the circular engaging portion 5d to prevent the occurrence of creak or any other inconvenience between the operating shaft 4 and the second interlocking member 5.

Then, the knob portion 4a of the operating shaft 4 thus supported by the second interlocking member 5 is inserted through the slit 2a of the first interlocking member 2 and is projected outwards from the operating hole 1f of the frame 1, allowing its circular base end portion 4b to be positioned in the slit 2a.

Further, the support portion 5h of the first arm portion 5f in the second interlocking member 5 is inserted into the circular hole 1g of the side plate 1a, allowing the component operating portion 5j formed as a tip portion to be projected outwards from the side plate 1a, and the support portion 5k of the second arm portion 5g is positioned in the support portion 1h of the side plate 1b of the frame 1.

Next, the frame 1 with the first and second interlocking members 2, 5 thus mounted therein is turned upside down, allowing the lower opening to face up. The return spring 7 is then fitted on the lower end 4h of the thus-inverted operating shaft 4 and is received in the receptacle space 4d of the cylindrical portion 4c.

Then, the axial bore 6c of the operating member 6 is fitted on the lower end 4h of the operating shaft 4, whereby the boss portion 6b of the operating member 6 is fitted movably into the cylindrical portion 4c of the operating shaft 4 and the operating member 6 comes into elastic contact with the return spring 7.

The bottom plate 8 with the push-button switch 9 secured temporarily to the component mounting portion 8c is inverted and attached to the inverted frame 1. At this time, end portions of the side plate 1c are guided by the guide portions 8d and the frame 1 is thereby positioned on the bottom plate 8. At the same time, the component holding legs 1j of the side plate 1b are positioned on the upper surface of the case 9b of the push-button switch 9 and the push-button switch is fixed to the bottom plate 8.

When the plural tongue pieces 1m extending downward from the side plates 1a and 1b of the frame 1 are caulked, the bottom plate 8 is rendered integral with the frame 1, the operating member 6 comes into elastic contact with the bottom plate 8, and the operating shaft 4 assumes its upright neutral state, as shown in FIG. 8.

Next, the operating portion 3e of one variable resistor 3 is brought into engagement with the component operating portion 5j of the second interlocking member 5 projecting outwards from the side plate 1a and the variable resistor 3 is engaged by snap-fitting with a plurality of rectangular holes (not shown) formed in the side plate 1a.

Likewise, the operating portion 3e of the other variable resistor 3 is brought into engagement with the component operating portion 2c of the first interlocking member 2 projecting outwards from the side plate 1c and the variable resistor 3 is secured to the side plate 1c. The assembling work for the multi-way input device is now over.

Although in the assembling work described above the electric components, i.e., the variable resistors 3, are secured to the frame 1 after mounting the first and second interlocking members 2, 5 to the frame 1, the variable resistors 3 may be mounted before mounting the first and second interlocking members 2, 5 to the frame 1.

The operation of the multi-way input device will now be described. First, when any operating force is not applied to the knob portion 4a of the operating shaft 4, that is, with no load applied, the operating member 6 is brought into elastic contact with the inner bottom 8b of the bottom plate 8 under the biasing force of the return spring 7 and the dish-like bottom of the base portion 6a of the operating member 6 assumes a horizontal state, while the operating shaft assumes its upright neutral state.

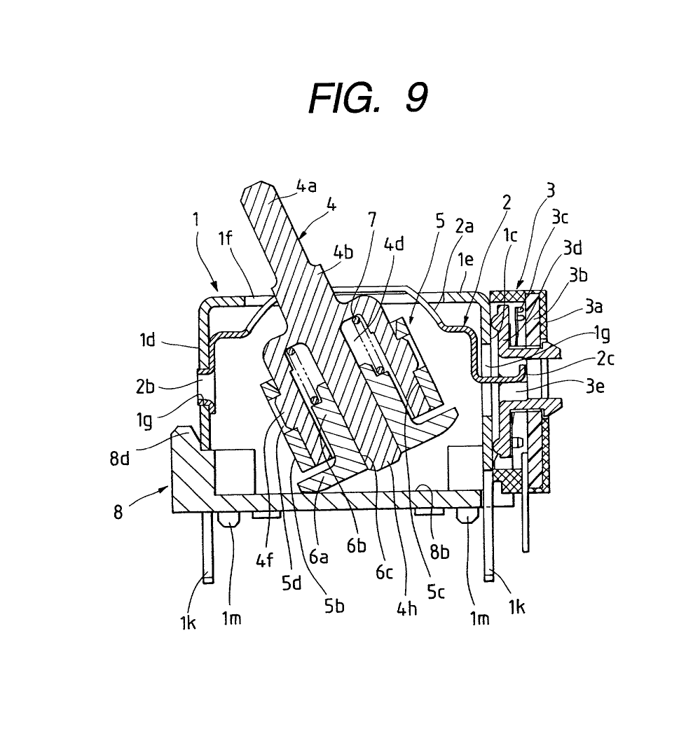

When an operating force acting in an arrow B direction is applied to the knob portion 4a of the operating shaft 4 which is in the neutral state, causing the operating shaft 4 to tilt, the second interlocking member 5 turns with the support portions 5h and 5k of the first and second arm portions 5f, 5g respectively as fulcrums. Further, as shown in FIG. 9, the bottom of the base portion 6a of the operating member 6 moves in sliding contact with the upper surface of the inner bottom 8b of the bottom plate 8 and the operating member 6 tilts while part of the outer periphery of the bottom of the base portion 6a is positioned on the inner bottom 8b of the bottom plate.

The boss portion 6b of the operating member 6 is pushed into the receptacle portion 4d of the cylindrical portion 4c of the operating shaft 4 against the biasing force of the return spring 7.

When the operating shaft 4 is tilted to rotate the second interlocking member 5, the slider receptacle portion 3d of the variable resistor 3 attached to the side plate 1a with which the component operating portion 5j of the first arm portion 5f is engaged, rotates and the resistance value of the variable resistor 3 changes.

When the operation of the variable resistor 3 attached to the side plate 1a is over and the operating force which has been exerted on the operating shaft 4 is relieved, the operating member 6 reverts to its horizontal state automatically with the biasing force of the return spring 7 and the operating shaft 4 reverts to its upright neutral state automatically.

When an operating force acting in an arrow A direction is applied to the operating shaft 4 to tilt the same shaft, the first interlocking member 2 rotates with both support portion 2b and component operating portion 2c as fulcrums.

Upon rotation of the first interlocking member 2, the slider receptacle portion 3d of the variable resistor 3, which is attached to the side plate 1c and with which the component operating portion 2c is engaged, rotates and the resistance value of the variable resistor 3 changes.

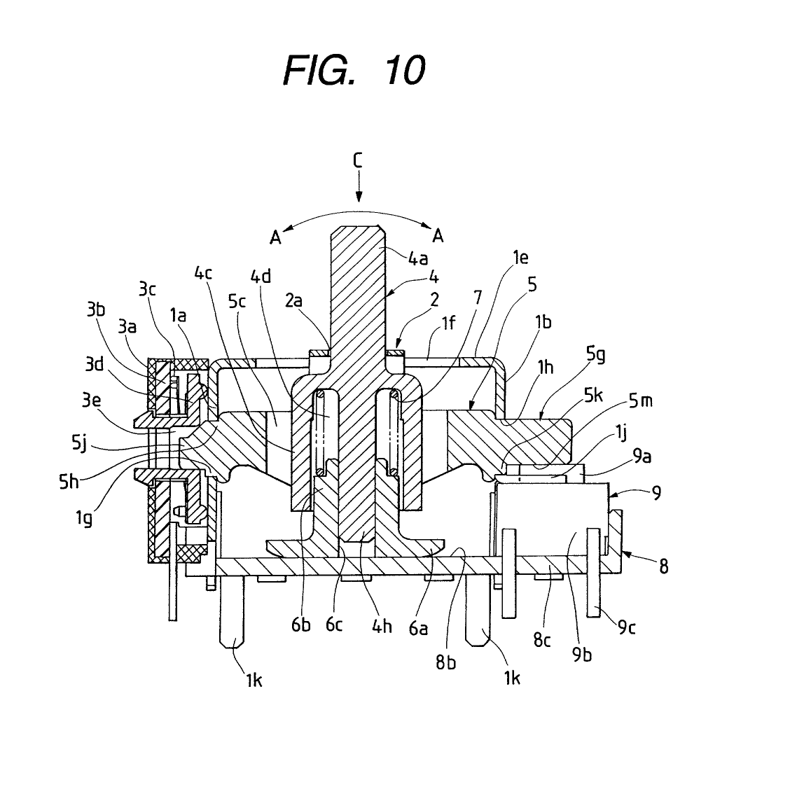

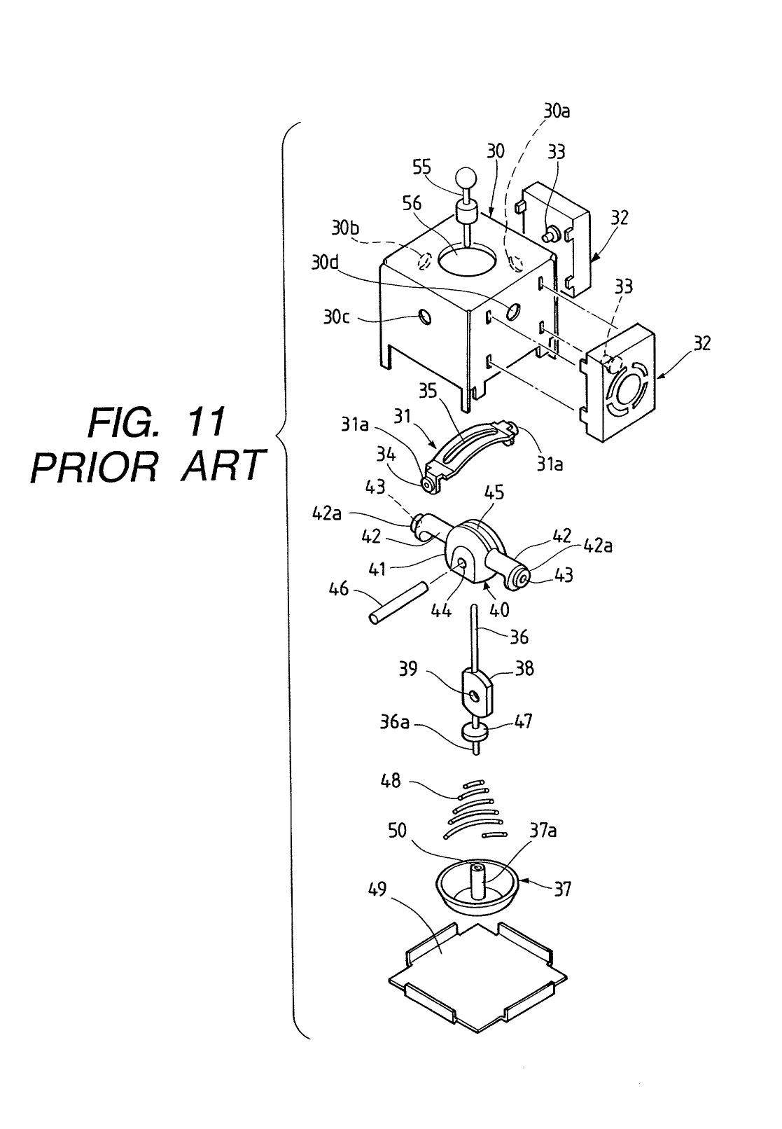

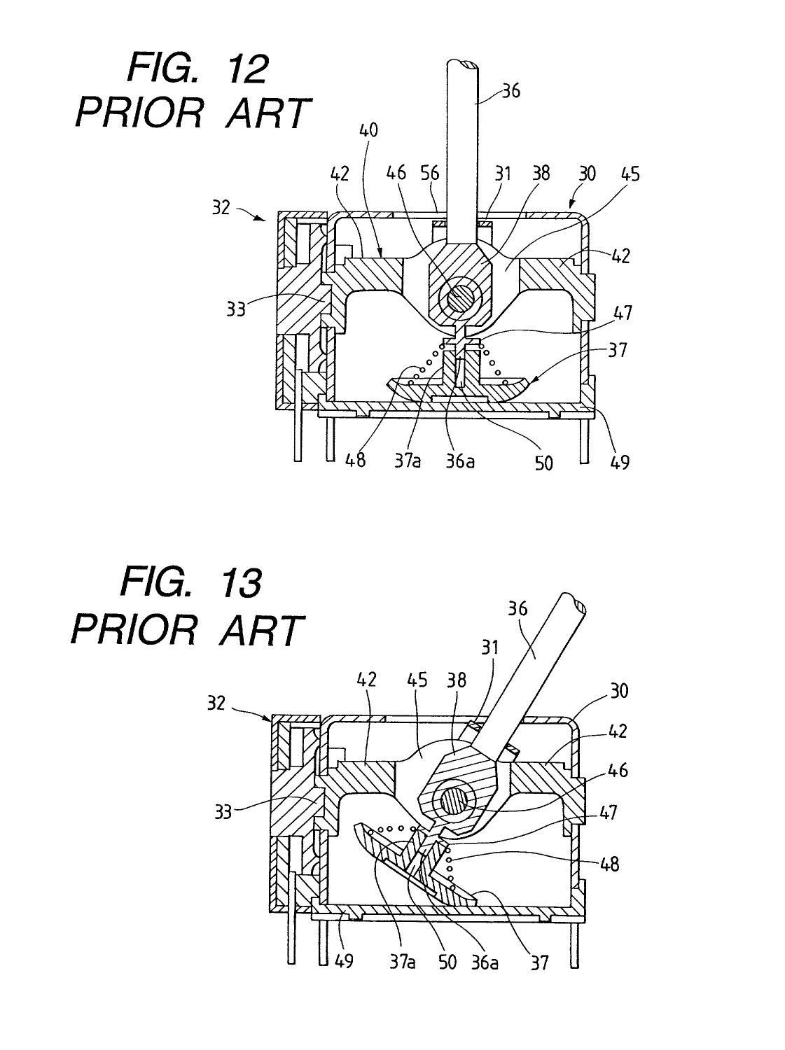

For operating the push-button switch 9, a downward load is applied in an arrow C direction to the operating shaft 4 which is in its neutral state shown in FIG. 10, to push the operating shaft.

As a result, the second arm portion 5g moves downward with the support portion 5h of the first arm portion 5f of the second interlocking member 5 as a fulcrum which member 5 is inserted into the circular hole 1g formed in the side plate 1a of the frame 1. With this movement of the second arm portion 5g, the component operating portion 5m at one end portion of the second interlocking member 5, which portion 5m projects outward from the semicircular support portion 1h of the frame side plate 1b, moves vertically and pushes the stem portion 9a of the push-button switch 9. In this way the push-button switch 9 can be turned ON and OFF.

The operating shaft 4 can be pushed in an arrow C direction not only when the operating shaft is in its neutral state but also after tilting of the operating shaft and after attainment of a predetermined resistance value of the variable resistor 3.

Although in the above embodiment the pivot shaft portions 4f formed on part of the outer wall of the cylindrical portion 4c of the operating shaft 4 are brought into engagement with the engaging portions 5d formed in side walls of the second interlocking member 5 which define the slot 5c and the operating member 4 is thereby supported tiltably by the second interlocking member 5, the operating member 4 may be pivotally supported through, for example, a round pin (not shown) in the second interlocking member 5.

Thus, in the multi-way input device of the present invention, no special limitation is placed on the shape of the pivot shaft portions 4f or the engaging portions 5d insofar as the cylindrical portion 4c of the operating shaft 4 is pivotally supported within the slot 5c of the second interlocking member 5.

Although in the above embodiment the pivot shaft portions 4f on the operating shaft 4 side are formed in a convex shape and the engaging portions 5d of the second interlocking member 5 are formed in a concave shape, the former may be formed concavely and the latter convexly.

Although in the above embodiment the variable resistors 3 and the push-button switch 9 were used as plural electric components, any other electric components may be used if only they can be rotated or pushed.

Although in the above embodiment the cylindrical portion 4c of the operating shaft 4 has a peripheral wall as an enclosure, the other portion than the portions where the pivot shaft portions 4f are formed may be open. In this case, in the assembling work involving engaging the pivot shaft portions 4f by snap-fitting with the engaging portions 5d of the second interlocking member 5, the pivot shaft portions 4f become easier to undergo elastic deformations and therefore the snap-fitting can be done more smoothly.

Although in the above embodiment the operating shaft 4 and the bottom plate 8 are formed using a synthetic resin, they may be formed using a metallic material such as a die casting alloy from the standpoint of ensuring a sufficient strength and preventing chipping caused by expiration of their service life.

Although in the above embodiment there is no tilt stopper on the knob portion 4a side during the tilting motion of the operating shaft 4, there may be adopted a modification such that a portion formed by drawing (not shown), such as an inverted bowl, which covers part of the slit 2a of the first interlocking member 2 from above, is provided at the center of the top plate 1e of the frame 1, and an aperture (not shown) against which the base end portion 4b of the knob portion 4a comes into abutment during the tilting motion of the operating shaft 4 is formed centrally of the inverted bowl-like drawn portion and is allowed to function as a tilt stopper for the operating shaft 4.

In the multi-way input device of the present invention, as set forth above, since the operating shaft is provided with a cylindrical portion having a return spring receptacle space and the cylindrical portion is pivotably supported within the slot of the second interlocking member, it becomes possible to dispose the return spring in the vicinity of the pivotally supported positions of the cylindrical portion and therefore it becomes possible for the multi-way input device to be reduced in thickness.

According to the second means adopted by the invention, the operating shaft has pivot shaft portions formed on part of an outer wall of its cylindrical portion, and the second interlocking member has engaging portions for engagement with the pivot shaft portions of the operating shaft, the engaging portions being formed in side walls of the second interlocking member which define the slot, the pivot shaft portions of the operating shaft being brought into engagement with the engaging portions of the second interlocking member to pivotally support the operating shaft in the second interlocking member. According to this construction, the pivot shaft portions formed on the outer wall of the cylindrical portion of the operating shaft can be brought into engagement by snap-fitting with the engaging portions of the second interlocking member and it is not necessary to use any special part such as a round pin for supporting the operating shaft and the second interlocking member. Thus, the multi-way input device is not only superior in the assembling work efficiency but also is reduced in the number of parts used and in cost.

According to the third means adopted by the invention, the pivot shaft portions of the operating shaft are formed in a convex or concave shape and the engaging portions of the second interlocking member for engagement with the pivot shaft portions of the second interlocking member are formed in a concave or convex shape, so through the engagement of the pivot shaft portions and the engaging portions, that is, through convex-concave engagement, the operating shaft can be surely engaged by snap-fitting with the second interlocking member and can thereby be prevented from coming off the second interlocking member.

According to the fourth means adopted by the invention, the operating member has a base portion whose bottom is dish-like and a boss portion formed at the center of the base portion and projecting toward the interior of the frame, the lower end portion of the operating shaft is inserted into an axial bore formed in the boss portion, and the boss portion being fitted movably in the receptacle space of the operating shaft. Therefore, even when the operating shaft is tilted, the boss portion of the operating member can be moved smoothly within the receptacle space of the operating shaft and thus the multi-way input device affords a good operation feeling of the operating shaft.

According to the fifth means adopted by the invention, since the return spring received in the receptacle space of the operating shaft is brought into elastic contact with the boss portion of the operating member, the operating member can be moved more smoothly within the receptacle space. Besides, since the return spring is received in the receptacle space, a lateral movement of the return spring can be diminished and its biasing force can surely be transmitted to the operating member. Consequently, upon release of the operating force exerted on the operating shaft, the operating shaft can be restored to its upright neutral position quickly and reliably.

Further, since the bottom of the operating member has an external shape larger than the receptacle space of the operating shaft, the amount of an axial movement of the operating member can be increased when the operating shaft is tilted, thus making it possible to increase the amount of deflection of the return spring. As a result, a large biasing force can be applied to the operating member, and the operating shaft, upon release of the operating force exerted thereon, can be restored to its upright neutral state rapidly and positively.

### ATTACHMENT A

| | |
|---|---|
| Guy W. Shoup | 26,805 |
| Allan J. Sternstein | 27,396 |
| Gustavo Siller, Jr. | 32,305 |
| John C. Freeman | 34,483 |
| William F. Prendergast | 34,699 |
| Vita G. Conforti | 39,639 |
| Mark H. Remus | 40,141 |
| Steven G. Steger | 40,185 |
| Tadashi Horie | 40,437 |
| Joseph F. Hetz | 41,070 |
| Jason C. White | 42,223 |

What is claimed is:

1. A multi-way input device comprising:
a first interlocking member which has a longitudinal slit and which is rotatable;
a second interlocking member disposed in a direction orthogonal to the longitudinal direction of said first interlocking member, said second interlocking member having a slot and being rotatable;
a frame within which said first and second interlocking members are mounted;
an operating shaft inserted through both said slit of the first interlocking member and said slot of the second interlocking member and supported tiltably by the second interlocking member;
a plurality of electric components attached to said frame and capable of being operated through said first and second interlocking members by operation of said operating shaft;
a return spring which restores said operating shaft to an upright neutral state automatically when the operating shaft is not in operation;
an operating member supported movably on a lower end portion of said operating shaft which is positioned in the interior of said frame; and
a bottom plate with which said operating member comes into elastic contact under the biasing force of said return spring and which closes the bottom side of said frame,
said operating shaft being provided with a cylindrical portion having a receptacle space for receiving said return spring therein, said cylindrical portion being pivotally supported within said slot of the second interlocking member.

2. A multi-way input device according to claim 1, wherein said operating shaft has pivot shaft portions formed on part of an outer wall of said cylindrical portion thereof, and said second interlocking member has engaging portions for engagement with said pivot shaft portions, said engaging portions being formed inside the slot of the second interlocking member, said pivot shaft portions of the operating shaft being brought into engagement with said engaging portions of the second interlocking member to pivotally support the operating shaft in the second interlocking member.

3. A multi-way input device according to claim 2, wherein said pivot shaft portions of said operating shaft are formed in a convex or concave shape and said engaging portions of said second interlocking member are formed in a concave or convex shape engageable with the pivot shaft portions.

4. A multi-way input device according to claim 1, wherein said operating member has a base portion whose bottom is dish-like and a boss portion formed at the center of said base portion and projecting toward the interior of said frame, a lower end portion of said operating shaft is inserted into an axial bore formed in said boss portion of the operating member, and said boss portion being fitted movably in said receptacle space of the operating shaft.

5. A multi-way input device according to claim 4, wherein said return spring received in said receptacle space of said operating shaft is in elastic contact with said boss portion of said operating member.

6. A multi-way input device according to claim 4, wherein the bottom of said operating member has an external shape larger than said receptacle space of said operating shaft.
